(19) United States
(12) Patent Application Publication
(10) Pub. No.: US 2008/0316005 A1
(43) Pub. Date: Dec. 25, 2008

(54) Communication by carrier current for centralized control centers

(75) Inventors: Olivier Coutelou, Grenoble (FR); Erick Contini, Meylan (FR); Laurent Dupuis, Grenoble (FR)

Correspondence Address: STEPTOE & JOHNSON LLP, 1330 CONNECTICUT AVENUE, N.W., WASHINGTON, DC, 20036, US

(73) Assignee: Schneider Electric Industries SAS, Rueil Malmaison (FR)

(21) Appl. No.: 12/155,799

(22) Filed: Jun. 10, 2008

(30) Foreign Application Priority Data
Jun. 25, 2007 (FR) 07014522

(51) Int. Cl. G05B 11/01

(52) U.S. Cl. 340/310.15; 290/40 R

(57) ABSTRACT

In an intelligent centralized control panel, in particular for motors in which case it is known under the name of iMCC, communications with the outside are performed by powerline carrier current or PLC. The wiring of the control panels can thereby be greatly reduced. To enable this type of communication to be used in dense systems containing a large number of line starters and therefore a large number of parallel-connected carrier current interfaces, the invention proposes inserting a preferably electronically adjustable impedance in series with the PLC conversion device. Advantageously, an adjustment algorithm enables the values of the added impedances to be optimized according to the geometry and position of the different interfaces.

### BACKGROUND OF THE INVENTION

The invention relates to control and monitoring modules suitable for intelligent centralized control panels in a preferred application for operation of motors, then called intelligent Motor Control Centers (iMCC).

More particularly, the invention relates to transmissions by powerline carrier current, or PLC, in iMCC, and to a method for adjusting the impedance of iMCC components for reliable operation. The modules and module panels according to the invention thus comprise adjustable impedance devices.

### STATE OF THE ART

Intelligent Motor Control Centers iMCC are low-voltage panels dedicated to power distribution, to control (and monitoring) and protection of motors, used in particular for continuous or semi-continuous processes in which the motor starters are located in the same place for operation and maintenance reasons. In particular, a programmable controller connects motor starter devices providing both electro-technical and measurement functions, via a communication network. Data of control type coming from the controller (power opening/closing) and of instrumentation type (data transfer) transit over the communication network. The scanning times between the different exchanges have to be controlled and preferably should be around a few hundred milliseconds.

However, for some applications, the very large number of motor starters to be integrated makes the wiring of an iMCC communication network complex and costly. Moreover, once the centralized panel has been completed, it becomes problematic to add a motor starter to an existing iMCC and/or to modify one of the elements thereof without having to dimension again the whole system.

To overcome this difficulty, it has been envisaged to make the data transit via the electric lines that are already present in the iMCC, which lines in particular supply the motor starters. According to the invention, the programmable controller and motor starters communicate by means of powerline carrier communication, or PLC, technology via auxiliary cables. The number of cables in intelligent motor control centers is therefore reduced, as is the number of connections, which lowers the final cost for the customer and simplifies maintenance. When performing assembly, the fitter's job is already made easier due to the reduction of the cable volume and of connections. This solution is for example mentioned in the document JP 2005157747.

However, although this type of communication seems particularly well suited for industrial sites, reliability and efficiency problems do still occur. In particular, the PLC signal attenuation may be very high and the useful PLC signal may therefore be too weak for optimal efficiency, in particular on sites presenting multiple iMCC each comprising a large number of motor starters. For application of communication by PLC technology in iMCC to operate correctly, the PLC products have to be adapted to take account of the specificities of the power supply system used to communicate with motors.

### SUMMARY OF THE INVENTION

Among other advantages, the object of the invention is to palliate the shortcomings of PLC transmission in centralized control and monitoring architectures of a large number of motors, in particular up to 400. More generally, the invention relates to a panel of several control and monitoring modules connected in parallel in dense manner, able to communicate with a central system via communication means, in particular of Ethernet type. The communication means inside the panel are as far as possible achieved by powerline carrier communication.

According to one feature, the invention relates to a control module of the panel, which comprises a line starter device, in particular designed to control and/or monitor a motor, for example an electronic relay, which can be connected to first communication means to transfer data in both directions to a PLC receiving and converting device. The first communication means are adapted to suit the line starter device: they may be formed by a serial line communication bus, for example using Modbus® SL protocol (i.e. a digital communication protocol of the ‘master-slave’ type using a serial line), or by a TCP/IP connection, or communication can be direct if the converter is integrated in the line starter device, or any other alternative.

The module according to the invention thus further comprises a carrier current interface comprising this receiving and converting device connected to a main powerline which can be connected to the electric power system by means of an input system. The main line of the carrier current interface, or PLC interface, according to the invention comprises an impedance matching device of the module, the impedance of which can notably reach 500 Ω, so that the impedance of the module takes at least two different values, a low value around that of the receiving/converting device, usually about 50 Ω, and a high value.

Advantageously, in a module according to the invention, power supply of the line input device is performed via the PLC interface, which then comprises an auxiliary powerline so that, preferably, a single connection of the power supply system to the module according to the invention is sufficient. The auxiliary powerline can in particular comprise a device which raises the impedance of the line starter device. Alternatively, this impedance raising device is connected to the line starter device.

The invention also relates to a panel comprising several previous modules, for example a set of twenty, or even one hundred and twenty modules on a line, or several columns (up to twenty) each comprising for example twenty modules, the main powerlines of which are connected to one and the same power supply. The PLC signal transiting via the powerline is read and/or generated by an incoming unit, for example a controller or a computer system. The incoming unit can be directly connected to the powerline to receive the PLC signals. According to a preferred embodiment, the incoming unit communicates via second communication means, for example an Ethernet connection. In this case, a second PLC signal converting/receiving device is connected between the panel according to the invention and the incoming unit.

Preferably, the second converting/receiving device is part of a second PLC interface, and all the PLC interfaces of an architecture according to the invention are identical. To adjust to the location of the PLC products, the impedance matching device on the main line of the PLC interface is variable. In particular, its impedance may be zero for a second interface connected to the incoming unit and high for a first interface forming part of a module according to the invention. The different impedance values of the module and/or of the PLC interface can be obtained by choosing between several branches of different impedance at the power supply input system.

According to a preferred embodiment, the matching device has an adjustable impedance that can be adjusted according to the use and location of the module according to the invention. Advantageously, the panel according to the invention further comprises electronic means enabling the values of this adjustable impedance to be adjusted on the basis of a memory of said means which gives the value of optimal impedances according to the architecture of the panel. These electronic means can form part of an incoming unit or be additional.

Advantageously, the electronic impedance adjustment means comprise determining means, for example algorithmic determining means, for adjusting the impedances one by one. Thereby, according to another feature, the invention relates to a method for adjusting the impedances of powerline carrier current interfaces in a control and monitoring panel.

In an intelligent panel comprising a plurality of modules according to the invention, either in the course of installation or during the usual operating process and when scanning operations are performed, the method according to the invention comprises a step of determining the optimal impedances of a set of interfaces from stored values and from the panel architecture, or even from the location of the modules. A consecutive adjustment step, either manual or preferably automated by self-adjustment, enables the architecture composed in this way to be optimized.

### BRIEF DESCRIPTION OF THE DRAWINGS

Other advantages and features will become more clearly apparent from the following description of particular embodiments of the invention, given for illustrative and non-restrictive example purposes only, represented in the accompanying figures.

FIG. 1 represents an existing iMCC according to an internal technology.

FIG. 2 schematically illustrates the solution according to the invention.

FIG. 3 schematically shows adaptations of the PLC interfaces for an iMCC according to the invention.

FIG. 4 shows another example of a module and architecture according to the invention.

### DESCRIPTION DETAILED OF A PREFERRED EMBODIMENT

Although it was developed to solve a problem inherent to a large density of communication devices, the invention applies to any control system comprising at least one line starter, for example a switchgear and/or power monitoring device, from and to which data transits. The module according to the invention enables the signal from the line starter device to be transformed and to be restored as a PLC signal. A notable example concerns a compact set of communicating devices, such as low-voltage panel line starters, or medium-voltage panel coupling devices, which are numerous over short distances. The invention finds a particular and preferred application in control and monitoring of motors by any suitable device, for example a variable speed drive, a contactor or a circuit breaker, and in particular by means of an electronic protection relay performing different motor protection and monitoring functions. The latter embodiment will be described in detail, but the person skilled in the art will transpose this teaching to the other uses of the module and panel according to the invention.

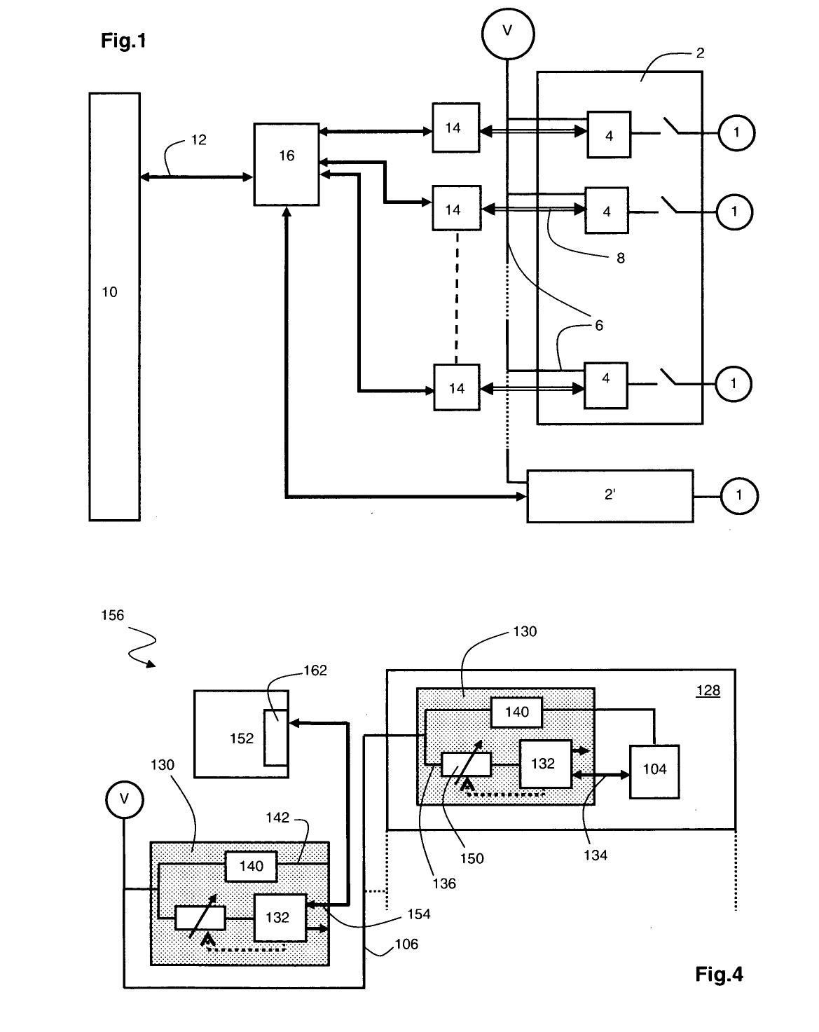

The solution according to the invention is preferably suitable for centralized motor control panels according to the state of the art, with at least the same capacities as far as number and speed of controls is concerned. For example, one type of control of motors 1 by an iMCC type panel 2 is illustrated in FIG. 1 in which each motor 1 is associated with a line starter device 4. An architecture compatible with the invention can be composed of a line 2 comprising up to 120 motors 1, or it may be in the form of a juxtaposition of lines, for example 20 columns 2, 2′ each comprising up to 20 motors 1. It should be understood that the terms lines and columns merely serve the purpose of differentiating the elements and that, although the columns are in fact often made up of a superposition of starters 4 over a height of about 2 m to 2.2 m, the notion of verticality is only relative.

Preferably, the line starter device is an electronic protection relay 4 supplied via a powerline 6 for example with 24 V DC current V, which transmits the data it receives via a communication bus 8, for example in Modbus® SL protocol, to a controller 10 which in addition controls each of the relays 4. Controller 10 can be located relatively distant from control panel 2, and communication is performed conventionally by an Ethernet connection 12, for example using a TCP/IP protocol. For this purpose, an Ethernet converter 14 is associated with each communication bus 8 of a relay 4, and a common switch 16 for panel 2, 2′ connects converters 14 to be connected by Ethernet 12 to controller 10. In a preferred application, iMCC 2 is able to update its data both on monitoring reception and on control send every 500 ms, preferably every 200 ms.

The number of connections to be made soon becomes bothersome and the size of the system considerable. Power supply line 6 of relays 4 is however always present in centralized control panels 2. According to the invention, what is involved is making programmable controller 10 and motor starters 4 communicate by means of a PLC (PowerLine Communication) technology via these cables 6. The PLC communication principle is based on injecting a signal of different frequency into a cable, in parallel with passage of the supply current, which signal will be detected by suitable means. In the scope of the invention, the frequency used is preferably higher than that of the power supply, in particular about 1 to 30 MHz. The addressing protocol by PLC is compatible with existing communication systems, and the TCP protocol of the architectures according to FIG. 1 30 therefore does not have to be modified. The invention applies in the previous case of auxiliary power supply in 24 V DC or 48 V DC, but also for 110 or 230 V AC, or even 24 or 400 V AC, or any other voltage.

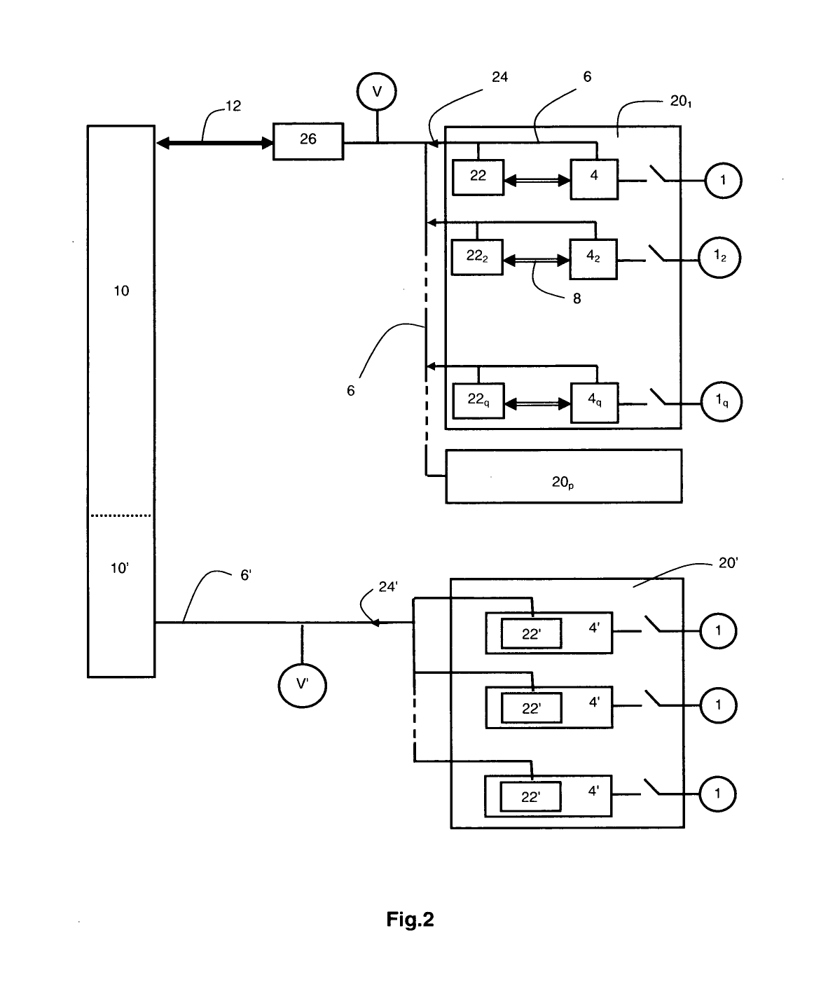

An iMCC 20 according to the principle of the invention is represented schematically in FIG. 2, where as many of the previous elements as possible have been kept, i.e. neither controller 10, nor relays 4, nor their communication means 8 have been modified. Panel 20 is represented schematically as a set of p columns 20ᵢ. Each relay 4 is thus both supplied by power supply line 6 and connected by its communication means 8 to a first PLC device 22, which is also connected to the powerline 6. PLC device 22 is of receiver/converter type and enables a signal flowing on line 6 to be transmitted by bus 8 to relay 4, and vice-versa. As second communication and monitoring means 12 of controller 10 preferably remain similar and comprise an Ethernet connection 12, PLC signal 24 from the different devices 22 is converted a second time for Ethernet at the level of a second powerline master device 26, the network 6, 22, 26 of iMCC 20 then being star-connected.

The communication means of controller 10′ can be modified by eliminating Ethernet line 12 and by direct communication via PLC. PLC signal 24′ then flowing on power supply line 6′ can be read and/or generated directly by controller 10′. In another embodiment, illustrated jointly for the sake of concision only, electronic relay 4′ can be modified to integrate a PLC receiver 22′, in which case data 24′ is transmitted directly from controller 10′ via supply line 6′ to receiver 22′ in relay 4′.

The choice of PLC communication in an iMCC panel moreover requires adaptations to obtain reliable and reproducible communications, given the compactness of the system obtained and the maximum use of the existing wiring.

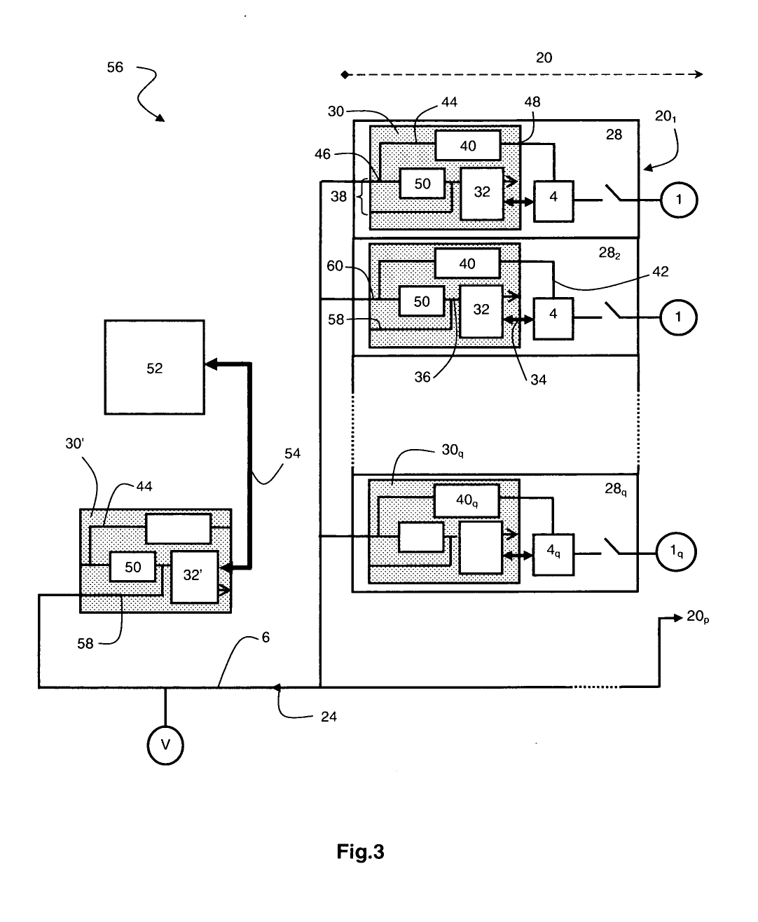

As illustrated in FIG. 3, a panel 20 according to the invention thus comprises p columns 20ᵢ which may each comprise qᵢ modules 28 for each of the q motors 1 of said column 20ᵢ. For the sake of concision, the indexes i relating to the columns will be left out in the rest of the description, the distinction between the columns of an iMCC 20 being relative to the construction of the iMCC rather than to its operation.

Each module 28 comprises a motor starter device 4 which is associated with a PLC interface 30. PLC interface 30 comprises a device 32 for converting/receiving signals which is associated with first communication means 34 and connected to a main powerline 36, the latter being connectable to power supply line 6 by means of a first power input system 38. Conversion means 32 transform the data transiting in the first communication means 34 by means of a first protocol into a representative PLC signal able to flow in powerline 36 and then power supply line 6, and vice-versa. First communication means 34 are connected to line starter device 4.

For the sake of clarity and concision, only the embodiment in which line starter 4 communicates with an external PLC converter/receiver 32 has been represented and described in detail. It is obvious that the solution according to the invention can be implemented in the same way for a PLC interface 22′ integrated in an electronic relay 4′, in which case first communication means 34 are internal.

In the applications of iMCC 20 shown in diagram form, p columns 20ᵢ of q starters 4ⱼ each are managed simultaneously, and therefore an electronic relay 4 is located near to each q×p first PLC interfaces 30 connected to power supply system 6, which relay is also supplied by power supply system 6. For an application to motors 1, starter devices 4 directly associated with the motors by nature present a low impedance, which is unfavorable for propagation of the PLC signals. As illustrated in FIG. 3, for each control module 28, the impedance of line starter device 4 is then preferably raised by an impedance matching device 40, for example two inductors, fitted on its supply line 42. Impedance raising device 40 is suitable for all types of power supply that may be encountered (direct or alternating current, PLC transmission at different frequencies). For example, for an application to motors 1 and with line starter devices 4 which can be the same electronic relays as before, the impedance Z₄₀ can be about 500 Ω.

According to a preferred embodiment of the invention, for the sake of ease of implementation and wiring, impedance matching device 40 of motor starter 4 is also integrated in first carrier current interface 30. Power supply 42 of line starter device 4 is performed via PLC interface 30 which then comprises an auxiliary powerline 44 between an input 46, which is preferably branched off from main line 36 at the level of power supply input system 38, and an output 48 connecting power supply 42 of line starter device 34. Impedance Z₄₀ is placed on this auxiliary line 44. Connection of the different modules 28 of a panel 20 is thereby made easier. Relay 4 is connected to connection output 48 and to communication bus 34 of PLC interface 30, and power supply 6 is then connected to first carrier current interface 30 at the level of its input 38.

In the particular case of applications to iMCC 20, the number of first PLC interfaces 30 connected in parallel in a panel 20 may be high, with p=120, each of the interfaces being able to be separated by a distance of less than 50 cm or 25 cm from the neighboring interface, or modules 28 are even separated by 10 cm on average from one another. Alternatively, columns 20ᵢ of twenty or so modules 28_{q} can be multiplied in an iMCC 20 by juxtaposing them up to p=20, and a high PLC interface density can then be obtained with q×p=200 or 400 points approximately, all in a small space with a height of 2 to 2.2 m over around twenty meters.

The standard impedance Z₃₂ of a PLC converter/receiver 32 is however about 50 Ω. The global impedance of the PLC line, also power supply line, 6, 36, therefore decreases significantly due to parallel connection of the different interfaces 30 additional to the operating elements 4 of motors 1 on a relatively short line 6. This low line impedance is here again detrimental to propagation of PLC signals 24, deteriorated communication taking place possibly between the most distant points 4_{1,1}, 4_{p,q} of line 6, 36, but also between two physically close points 4₁, 4₂, separated for example by 10 to 20 cm. Correct operation of the installation and of motors 1 may be reduced or even prevented.

To avoid this significant impedance drop of line 6, a second impedance matching device 50 is added in series with PLC converter 32 in interface 30. Matching circuit 50 is connected between the first input system or connector 38 and conversion device 32, on powerline 36, so that a second impedance Z₅₀, preferably high and for example of about 500 Ω, is added to standard first impedance Z₃₂ to constitute the third impedance of carrier current interface 30 as such: Z₃₀=Z₃₂+Z₅₀ (=550 Ω for example). Impedance matching device 50 thereby enables the impedance of input module 28 to have at least a low first value and a high second value.

Although it is a priori obvious, this solution goes against the usual practices of the person skilled in the art, given that it is known that a PLC product has to have a low impedance in order to optimize data transmission. Adding the second matching circuit 50 makes PLC converter 32 lose a few dB. However, it was found during development of the invention that this temporary loss is more than compensated by the global gain of system 20 which benefits from a PLC line 6 with an impedance which remains sufficiently high for good signal propagation. In other words, by reducing the power of the signal slightly and locally, communication over the whole system is made possible and optimized.

In the case of a star-connected configuration, it is advantageous to privilege second carrier current interface 30′ (i.e. the central master product), which is not connected in parallel with all the others. For this purpose, second PLC interface 30′ preferably keeps the standard first low impedance (about 50 Ω), whereas the other PLC interfaces 30, connected to starter relays 4 of motors 1, have their impedance adapted by insertion of previously defined circuit 50 so that module 28 takes a high second impedance value.

Second master PLC product 30′ is designed for communication between panel 20 of modules 28 according to the invention and an incoming control and monitoring unit 52, for example a controller or computer. In this respect, central PLC interface 30′ comprises signal conversion means 32′ associated with second communication means 54 and connected to electric power supply line 6. Conversion means 32′ transform the data transiting in second communication means 54 which are connected to control system 52 into a representative PLC signal able to flow in power supply line 6, and vice-versa.

According to a preferred embodiment, all the carrier current interfaces 30, 30′ related to a monitoring architecture 56 comprising an iMCC 20 according to the invention are identical. In particular, conversion means 32 of PLC interface 30 perform conversion of the PLC signals to convey them via two communication means 34, 54 which may be different and which are selected for connection to incoming unit 52 or to a relay 4 depending on the location of product 30, 30′ in the architecture 56.

As far as impedance 50 added to first interfaces 30 and not to master interfaces 30′ is concerned, one embodiment concerns formation of electric power supply input system 38 of interface 30 in two inputs to two distinct branches 58, 60 of main line 36. First branch 58, a simple line, corresponds to a first low impedance input, mainly standard impedance Z₃₂, and will be used for central PLC product 30′ connected to controller 52. Second branch 60 comprises impedance matching device 50: this high impedance input (Z₃₂+Z₅₀) is used for modules 28 according to the invention. When PLC interface 30 further comprises impedance matching device 40 of motor starter 4, connection 46 of auxiliary line 44 is performed on second branch 60, between input system 38 and impedance 50.

This embodiment can be finely tuned by multiplying the number of input branches 58, 60 of main powerline 36 of PLC interface 30 to adapt to different connection modes, different star-connected architectures, and different line input devices 4.

According to another embodiment, impedance matching relating to parallel connection of numerous PLC interfaces is optimized by installation of an architecture 56 implementing products whose added impedances according to the invention have adjustable values. The value Z of the added impedances can then be chosen according to the type of topology (p,q) of the PLC line and/or the number p×q of interfaces connected to the line and/or the location i,j of the interface connected on the line.

A second embodiment of a module 128 according to the invention is illustrated in FIG. 4, the reference numbers being incremented by 100 with respect to the first embodiment. Here again, PLC interface 130 can be used as master or as converter of line starter devices 104. It advantageously comprises an auxiliary powerline 144 with a fixed or variable impedance matching device 140 of line input device 104. PLC interfaces 130 comprise a main powerline 136 of PLC converter/receiver 132 on which a variable impedance device 150 is connected, the impedance of which device 250 can be adjusted between two values, notably zero and a maximum value. Adjustment can be manual, for example by adjustment means of potentiometer type, or be performed by software programming, with an electronic means 162 which adjusts the impedance value Z₁₅₀ according to a preset value.

According to an advantageous option, the optimized values of impedances Z₁₅₀ are stored in a memory of said electronic adjustment means 162. Electronic adjustment means 162 can in particular form part of control and monitoring unit 152. The preset value of impedances Z₁₅₀ to be adjusted can be calculated. Alternately, in particular if architecture 156 is complex, once the geometry of system 106, 120 has been defined, “tables of values” can be drawn up by learning with measurements or by simulations on a PLC line simulation tool and stored. The optimized impedance value Z₁₅₀ parameter is then set on PLC interface 130 when installation is performed.

According to an advantageous option, matching of the different impedances 150 of first PLC interfaces 130 present on iMCC 120 according to the invention is finely tuned by automating adjustment product by product during the installation phase of modules 128 according to the invention. Control and monitoring architecture 156 is thereby set up by connecting each module 128 successively. The additional attenuation of the PLC signal due to connection of a new interface 130ₙ₊₁ to a panel 120 of n modules 128 (and therefore of a low fault impedance product on line 106) is sufficiently weak for the data to be able to be communicated by PLC.

In particular, in such an installation algorithm, electronic adjustment means 162, for example forming part of incoming unit 152, store tables of values corresponding to partial architectures containing a number i·j of modules 28 in panel 20, or by distinguishing between the locations (i,j) of each module. Alternately, the values stored in electronic adjustment means 162 can be supplied as the system evolves by a simulation algorithm of the memory. For example, if the partial panel of n modules 128 installed with optimized values Z₁₅₀ is considered:
when a new module 128ₙ₊₁ is detected by the installation algorithm of centralized control panel 120, for example during a broadcast (namely by a request to establish an inventory over the network), the determining means, for example an algorithm, search for an optimal value of the different impedances Z′₁₅₀ for n+1 modules 128 in the memory;
the n+1 optimized values of impedances Z′₁₅₀ determined in this way are then sent to each PLC interface 130i on the whole set of modules 128_{1→n+1} to modify their impedances accordingly by self-adjustment.

This process is reiterated each time a new interface 130 is connected. Step by step, by adding modules 128 one by one, the whole iMCC 20 is configured optimally.

Although it gives satisfactory results on start-up and installation of an iMCC 20, this algorithm for determining and adjusting impedances Z₁₅₀ is not optimized for maintenance or repair operations which involve changing a PLC interface 130 or a module 128 of iMCC 120. It would then be necessary to go back through the installation and optimization phase of impedances Z₁₅₀ one by one, which means interrupting the production process, which may be extremely penalizing and even non-envisageable for iMCC applications.

To overcome this drawback, a modified algorithm can be set up by the determining means and for example be integrated in the scanning process in production mode. A constant exchange of data does in fact take place between incoming unit 152 and PLC conversion/reception devices 132 to monitor and control line starter devices 104 (in particular every 200 ms). Broadcast requests can be added to these exchanges, which requests query the whole of the system in parallel manner, or from time to time, to check whether there is another architecture 156 of PLC interface 130 on line 106. Here again, the speed of the exchanges implies a minor modification of the architecture 156 so that the resulting PLC signal is not strongly attenuated and can transmit the necessary data. If this is the case, the scanning process in production mode and the automatic impedance adjustment process described above are mixed in time until the automatic impedance adjustment process has been terminated.

In particular, according to a preferred embodiment of the method stemming from use of this algorithm, the following succession of steps is performed:
1/ incoming unit 152 establishes control and monitoring requests of line starter devices 104, according to a standard process in production mode, with the different PLC interfaces 130, and incoming unit 152 sends an additional request to establish an inventory of PLC interfaces 130 connected to line 106;
2/ an algorithm of incoming unit 152 analyzes the responses to the control and monitoring requests and adjusts the commands of line starter devices 104 according to a standard process in production mode;
3/ an algorithm counts the number of responses and notes the number n of PLC interfaces 130 connected to line 106;
4/ if the number n of PLC interfaces 130 counted in step 3/ is identical to the number n of PLC interfaces 130 counted when the previous requests were made, incoming unit 152 resumes its requests as in first step 1/;
5/ if the number n of PLC interfaces 130 counted in step 3/ is different from the number of PLC interfaces 130 counted when the previous requests were made, then:
   5a the algorithmic determining means of adjustment means 162 search for optimized impedance values Z₁₅₀ in the table of values for n PLC interfaces 130;
   5b optimized values Z₁₅₀ are sent to each of the PLC interfaces and local self-adjustment of impedance 150 of each of the n PLC interfaces 130 is performed according to the optimized values;
5c incoming unit 152 resumes its requests as in first step 1/.

Here again, in step 1/, inventory of the interfaces can include a transfer relative to individual addressing of PLC interfaces 130_{i,j}, and step 5/ may comprise a comparison between the locations so as to optimize impedances Z′₁₅₀ also according to the positions (i,j) of modules 128 on line 106. The impedance determining means and adjustment means 162 can also take the second interfaces into account in star-connected architectures 156 and for example not assign them a zero impedance Z₁₅₀.

In this way, according to the invention, impedance matchings of a PLC communication system are optimized for the particular use in iMCC for each system architecture. The use of PLC communication therefore becomes possible in this application where reliability is imperative.

Thanks to the solution provided by the invention, it is therefore possible to take advantage of PLC technology in intelligent Motor Control Centers. In particular, powerline communication in the electrical panels (high-frequency propagation in duct), with impedance matching, is well suited to large sites presenting a large number of iMCC close to one another, a geometry which would generate interferences for radio or WLAN (Wireless Local Area Network) communications.

In addition, whatever the power supply distribution system (chaining, branching, . . . —direct or alternating current), and whatever the type of power supply cable used (standard cable or wire, shielded wire, auxiliary sheathing system, . . . ), the PLC solution is envisageable and advantageous. In particular, installing the additional impedances and adapting them on existing panels does not cause any problems, and it is possible to go from a conventional non-communicating panel to an iMCC panel. Renovation without complete restructuring or replacement for similar results is enabled by the principle according to the invention.

1. A control and monitoring module suitable for use in a panel comprising a carrier current interface with a first input system of an electric power supply; a line starter device with an electric power supply input; and first communication means able to be connected between the line starter device and the carrier current interface for transmitting data according to a first protocol between the two;
wherein the carrier current interface comprises:
a powerline connected to the first input system comprising impedance matching means located on said powerline so that the carrier current interface has an impedance able to take at least a first and a second value which are different from each other; and
a signal conversion/reception device connected to the first communication means and to said powerline of the carrier current interface, said device being able to transform the data transiting in the first communication means from the first protocol into a representative carrier current signal able to transit via the powerline and vice-versa.

2. The module according to claim 1 wherein the first input system of the carrier current interface comprises at least two distinct inputs, and the powerline is connected to each of the inputs by a branch, the impedance of each branch being different.

3. The module according to claim 1 wherein the impedance matching means comprise a device for adjusting the impedance on the powerline of the carrier current interface.

4. The module according to claim 1 wherein the carrier current interface comprises an auxiliary powerline between an input and an output designed to be connected to the power supply input of the line starter device, the auxiliary powerline comprising an impedance matching device.

5. The module according to claim 1 wherein the signal conversion/reception device can be connected to second communication means and is able to transform the data transiting in the second communication means into a representative carrier current signal able to transit via the powerline, and vice-versa.

6. The module according to claim 1 wherein the line starter device is able to control a motor.

7. A centralized control panel comprising a plurality of modules according to claim 1, said modules being connected to one and the same electric powerline via which the carrier current signal of each conversion and reception device can transit.

8. The centralized control panel according to claim 7 associated with an incoming unit connected to the common powerline, said incoming unit being able to receive and transmit carrier current signals on said powerline to monitor and control the line starter devices.

9. The centralized control panel according to claim 7 further comprising at least one second carrier current interface which comprises a conversion and reception device connected to the powerline of the modules of the control panel and connected to communication means, said device being able to transform the representative carrier current signal able to transit via the powerline into data transiting in said communication means.

10. The centralized control panel according to claim 9 associated with an incoming unit connected to the communication means of the second carrier current interface, said incoming unit being able to communicate via said communication means to monitor and control the line starter devices.

11. The centralized control panel according to claim 7 wherein all the carrier current interfaces are identical.

12. A centralized control panel comprising a plurality of control and monitoring modules connected to one and the same common electric powerline, wherein each module comprises: a carrier current interface; a line starter device with an electric power supply input; and first communication means able to be connected between the line starter device and the carrier current interface for transmitting data according to a first protocol between the two;
wherein the carrier current interface comprises:
a first input system of an electric power supply connected to said electric powerline and to a principal line of said carrier current interface;
impedance matching means comprising a device of adjustable impedance between two different values and located on said principal line; and
a signal conversion/reception device connected to the first communication means and to said principal line, said device being able to transform the data transiting in the first communication means from the first protocol into a representative carrier current signal able to transit via the principal line and the electric powerline and vice-versa.

13. The centralized control panel according to claim 12 wherein all the carrier current interfaces are identical and the line starter devices are able to control a motor

14. The centralized control panel according to claim 12 further comprising electronic means for adjusting the values of the adjustable impedances on the basis of a memory of said means giving the value of optimal impedances according to the control panel architecture.

15. The centralized control panel according to claim 14 further comprising at least one second carrier current interface which comprises a conversion and reception device connected to the principal line of the modules and connected to communication means, said device being able to transform the representative carrier current signal able to transit via the powerline into data transiting in said communication means.

16. The centralized control panel according to claim 15 associated with an incoming unit connected to the communication means of the second carrier current interface, said incoming unit comprising the electronic means and being able to communicate via said communication means to monitor and control the line starter devices.

17. An automated installation method of a control panel according to claim 14 by successive parallel connection of the modules of the control panel comprising: installation of a module of the control panel; determination for the installed architecture of the optimal impedance values of the interfaces for transmission by carrier current by the electronic means; adjustment by said electronic means of the impedances of all the adjustable impedance devices on the optimal values determined; and reiteration of the method by installing a new module of the control panel.

18. A method for scanning and adjustment of the impedances of a control panel according to claim 14 comprising:
a first step of establishing control and monitoring requests of the line starter devices with the interfaces and a request to determine the number of interfaces;
a second step of adjusting the impedances of all the adjustable impedance devices by the electronic means when the number of interfaces determined when the determination request is made is different from the previously determined number of interfaces;
reiteration of the scanning and adjustment method.

19. The method according to claim 18 wherein the control panel is according to claim 16.

20. A method for adjustment of the impedances of a centralized control panel according to claim 12 comprising:
determining the architecture of the control panel comprising determining the number of carrier current interfaces;
determining for said architecture the optimal impedance values of the interfaces for transmission by powerline carrier current;
adjusting the impedances of all the adjustable impedance devices on the optimal values determined.
